(19) United States
(12) Patent Application Publication
(10) Pub. No.: US 2018/0196959 A1
(43) Pub. Date: Jul. 12, 2018

(54) LOG OUTPUT APPARATUS AND LOG OUTPUT METHOD

(71) Applicant: FUJITSU LIMITED, Kawasaki-shi (JP)

(72) Inventors: Yoko Yonemoto, Nagoya (JP); Kiyoshi KOUGE, Kuwana (JP); Katsuaki Kawaguchi, Toyoake (JP)

(73) Assignee: FUJITSU LIMITED, Kawasaki-shi (JP)

(21) Appl. No.: 15/848,261

(22) Filed: Dec. 20, 2017

(30) Foreign Application Priority Data
Jan. 6, 2017 (JP) 2017-001029

(51) Int. Cl. G06F 21/62

(52) U.S. Cl. CPC G06F 21/6245

(57) ABSTRACT

A log output apparatus includes, a memory and a processor coupled to the memory and the processor configured to, specify an occurrence time when an incident has been occurred, specify, from among a plurality of logs included in log information of software, a first log acquired within a first period according to the occurrence time and a second log acquired within a second period other than the first period in accordance with the log information stored in the memory, and output new log information in which character information included in the first logs is converted into first character information having confidentiality higher than confidentiality of the character information and besides character information included in the second logs is converted into second character information having confidentiality higher than confidentiality of the first character information.

### CROSS-REFERENCE TO RELATED APPLICATION

This application is based upon and claims the benefit of priority of the prior Japanese Patent Application No. 2017-001029, filed on Jan. 6, 2017, the entire contents of which are incorporated herein by reference.

### FIELD

The embodiment discussed herein is related to a log output apparatus and a log output method.

### BACKGROUND

In recent years, together with performance improvement of physical machines, research of a virtualization technology for aggregating a plurality of virtual machines into one physical machine is underway. According to this virtualization technology, for example, virtualization software (hereinafter referred to also as hypervisor) allocates physical resources of a physical machine to a plurality of virtual machines to make it possible to provide a service by the software installed in each virtual machine.

In recent years, lending of a virtual machine to a business operator who performs provision and so forth of a service utilizing a virtual machine (such business operator is hereinafter referred to as service business operator) is performed by a business operator who provides a utilization environment of a virtual machine such as a resource, or an infrastructure of a physical machine (such business operator is hereinafter referred to also as cloud business operator). For example, a cloud business operator carries out lending of a virtual machine to a service business operator, for example, based on conditions set in a contrast.

Such a cloud business operator as described above accumulates a log outputted upon utilization of a virtual machine by a service business operator (such log is hereinafter referred to also as log information) into a storage device. Then, for example, if the cloud business operator accepts an inquiry about an event or the like occurring in a virtual machine from a service business operator, the cloud business operator extracts a desired log from among logs accumulated in the storage device and conducts an investigation for the accepted inquiry (for example, refer to Japanese Laid-open Patent Publication No. 2012-190345, Japanese Laid-open Patent Publication No. 2011-237975, Japanese Laid-open Patent Publication No. 2010-9223 and Japanese Laid-open Patent Publication No. 2014-235568).

### SUMMARY

According to an aspect of the embodiment, a log output apparatus includes, a memory and a processor coupled to the memory and the processor configured to, specify an occurrence time when an incident has been occurred, specify, from among a plurality of logs included in log information of software, a first log acquired within a first period according to the occurrence time and a second log acquired within a second period other than the first period in accordance with the log information stored in the memory, and output new log information in which character information included in the first logs is converted into first character information having confidentiality higher than confidentiality of the character information and besides character information included in the second logs is converted into second character information having confidentiality higher than confidentiality of the first character information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1 and 2 are views depicting a configuration of an information processing system;

FIG. 3 is a view depicting a hardware configuration of an information processing apparatus;

FIG. 4 is a functional block diagram of an information processing apparatus;

FIG. 5 is a flow chart illustrating an outline of a log outputting process in a first embodiment;

FIGS. 6 and 7 are views illustrating an outline of the log outputting process in the first embodiment;

FIGS. 8 to 14 are flow charts illustrating details of the log outputting process in the first embodiment;

FIG. 15 is a view illustrating a particular example of incident information;

FIG. 16 is a view illustrating a particular example of log information stored in a storage device;

FIGS. 17 and 18 are views illustrating particular examples of a log acquired from log information stored in a storage device;

FIG. 19 is a view illustrating a particular example of authentication information;

FIG. 20 is a view illustrating particular examples of a log acquired from log information stored in a storage device;

FIG. 21 is a view illustrating a particular example of utilization information;

FIGS. 22 to 25 are views illustrating particular examples of a log acquired from log information stored in a storage device;

FIG. 26 is a view illustrating another particular example of incident information; and

FIG. 27 is a view illustrating a particular example of a log acquired from log information stored in a storage device.

### DESCRIPTION OF EMBODIMENT

When such a cloud business operator as described hereinabove performs accumulation of logs into a storage device, the cloud business operator sometimes accumulates logs outputted from a virtual machine lent to different service business operators without distinguishing the logs from each other. Therefore, a person in charge of the cloud business operator who conducts an investigation for an inquiry (such person is hereinafter referred to also as person in charge of support) sometimes fails to perform extraction only of logs relating to a service business operator from whom the inquiry is received. Accordingly, when the person in charge of support conducts an investigation for the inquiry, for example, the person will extract logs including logs relating to other service business operators (logs that are not used in the investigation) and conduct an investigation for the inquiry.

However, there is the possibility that the logs accumulated in the storage device may include personal information or the like of persons who utilize a service provided by the service business operator (such person is hereinafter referred to also as user). Therefore, the cloud business operator preferably reduces opportunities for the person in charge of support to view logs relating to other service business operators as far as possible.

In contrast, the cloud business operator performs concealment of information included in the extracted logs, for example, before the person in charge of support performs viewing of the logs. Consequently, the cloud business operator may suppress the person in charge of support from viewing logs relating to a different service business operator.

However, in this case, there is the possibility that concealment may be performed also for logs to be used for an investigation for an enquiry (logs relating to the service business operator from which the inquiry is received) from among the logs extracted from the storage device. Therefore, the person in charge of support sometimes fails to conduct a sufficient investigation for the inquiry.

[Configuration of Information Processing System]

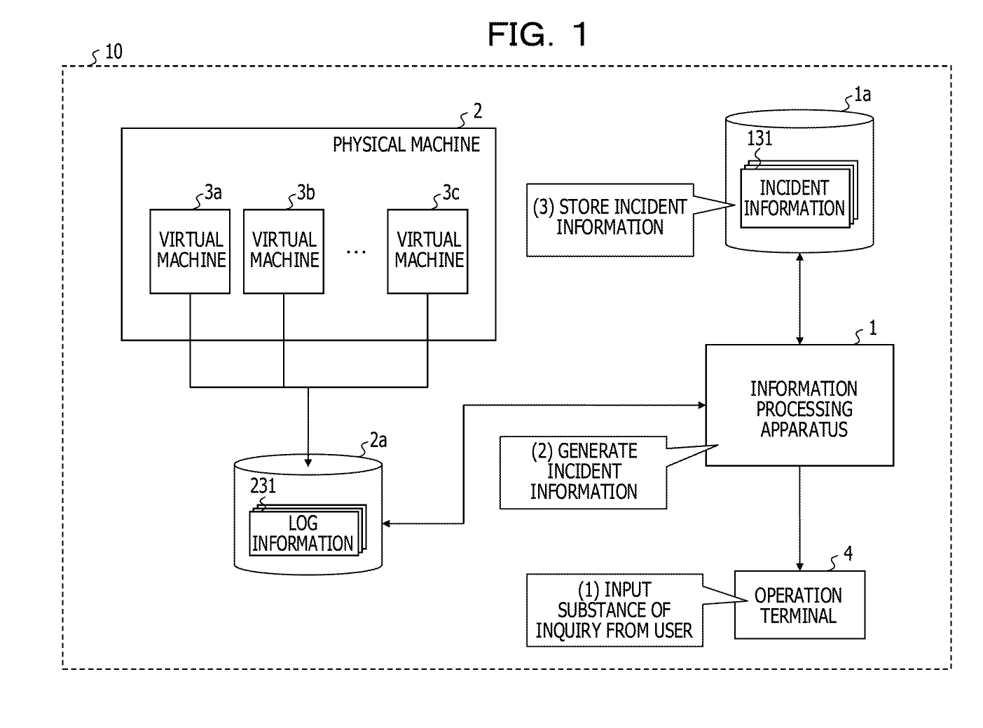

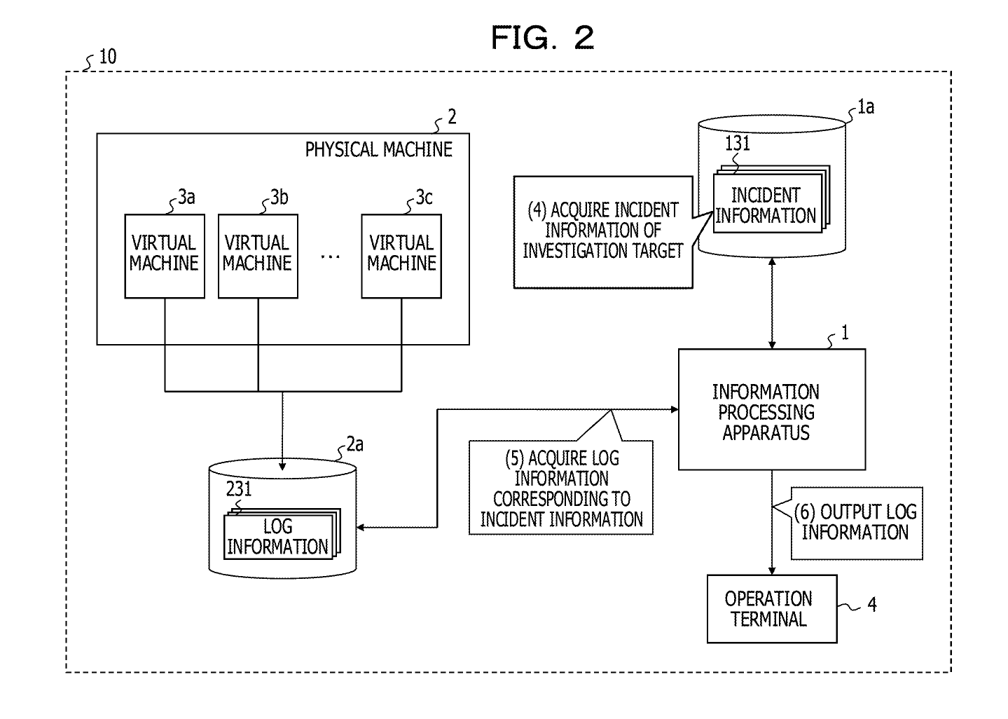

First, a configuration of an information processing system 10 is described. FIGS. 1 and 2 are views depicting a configuration of the information processing system 10. The information processing system 10 depicted in FIG. 1 typically includes an information processing apparatus 1, a physical machine 2 and an operation terminal 4.

The physical machine 2 is configured from one or more physical machines. Each of the physical machines includes, for example, a central processing unit (CPU), a memory (dynamic random access memory: DRAM), a hard disk (hard disk drive: HDD) and so forth. The physical resources of the physical machine 2 are allocated to a plurality of virtual machines 3 (in the example depicted in FIG. 1, to virtual machines 3a, 3b and 3c).

Each virtual machine 3 renders, for example, a business system (not depicted) for allowing a service business operator to provide a service to users operative. Then, each virtual machine 3 accumulates a log generated upon operation of the business system as log information 231 into the storage device 2a.

The operation terminal 4 is a terminal for inputting, for example, when a user makes an inquiry about a service to a person in charge of support, the substance of the inquiry (hereinafter referred to also as incident) accepted by the person in charge of support ((1) in FIG. 1). The operation terminal 4 is, for example, a personal computer (PC).

Further, for example, when an input of the substance of an incident is received from the operation terminal 4, the information processing apparatus 1 forms incident information 131 from the substance of the inputted incident ((2) of FIG. 1). Then, the information processing apparatus 1 stores the formed incident information 131 into the storage device 1a ((3) of FIG. 1).

Further, for example, if an input that an investigation of an incident is to be conducted is received from the person in charge of support through the operation terminal 4, the information processing apparatus 1 acquires the incident information 131 corresponding to the incident of an investigation target from the storage device 1a ((4) of FIG. 2). Then, the information processing apparatus 1 acquires the log information 231 corresponding to the incident information 131 acquired from the storage device 1a from the storage device 2a ((5) of FIG. 2). Thereafter, the information processing apparatus 1 transmits, for example, the log information 231 acquired from the storage device 2a to the operation terminal 4 ((6) of FIG. 2). Consequently, the person in charge of support may acquire the log information 231 for conducting an investigation of the incident information 131 of the investigation target.

Here, when such a cloud business operator as described above performs accumulation of logs into the storage device 2a, logs outputted from virtual machines lent out to different service business operators are sometimes accumulated collectively. In this case, in the logs accumulated in the storage device 2a, logs outputted from the virtual machines 3 utilized individually by a plurality of service business operators are included without being sorted. Therefore, the person in charge of support sometimes fails to perform extraction only of logs relating to the service business operator from which an inquiry has been received. Accordingly, when the service business operator conducts an investigation for an inquiry, it is significant for the service business operator to conduct an investigation while viewing logs including logs that relate to other service business operators (logs that are not used in the investigation).

However, there is the possibility that the logs accumulated in the storage device 2a may include personal information of users and so forth. Therefore, the cloud business operator preferably minimizes opportunities of the person in charge of support in viewing of logs related to other service business operators.

Therefore, the cloud business operator performs concealment of information included in the extracted logs, for example, before the person in charge of support views the logs. Consequently, the cloud business operator may suppress viewing of the logs related to the other service business operators by the person in charge of support.

However, in this case, there is the possibility that concealment may be performed also for logs to be used in an investigation for an inquiry (logs relating to the service business operator from which the inquiry has been received) from among the logs extracted from the storage device 2a. Therefore, the person in charge of support sometimes fails to perform sufficient investigation for the inquiry.

Therefore, the information processing apparatus 1 in the present embodiment specifies a generation time point of each of incidents whose information is included in the incident information 131. Then, the information processing apparatus 1 refers to the storage device 2a in which the log information 231 of software is stored to specify, from among a plurality of logs included in the log information 231, logs acquired within a period according to the specified generation time point (such logs are hereafter referred to also as first logs). Further, the information processing apparatus 1 refers to the storage device 2a in which the log information 231 of software is stored to specify, from among the plurality of logs included in the log information 231, logs acquired within any other period than the period according to the specified generation time point (such logs are hereinafter referred to also as second logs).

Thereafter, the information processing apparatus 1 converts character information included in the first logs into character information having higher confidentiality than confidentiality of the character information (character information having higher confidentiality is hereinafter referred to also as first character information) and converts character information included in the second logs into character information having higher confidentiality than confidentiality of the first character information (character information having higher confidentiality is hereinafter referred to also as second character information). Then, the information processing apparatus 1 outputs new log information (also called log information 231a) obtained by converting the character information included in the first logs and the second logs.

For example, the possibility that a log used in an investigation of an incident of an investigation target may have been acquired (stored) at a time point close to a generation time point of the incident of the investigation target is high. Therefore, the information processing apparatus 1 performs concealment of logs included in the log information 231 such that the confidentiality of any log acquired at a time point close to a generation time point of an incident of an investigation target becomes lower than the confidentiality of any other log.

This makes it possible for the information processing apparatus 1 to make the confidentiality of a log, which has high possibility in use in the investigation, relatively low and make the confidentiality of a log, which has low possibility in use in the investigation, relatively high. Therefore, the information processing apparatus 1 may maintain the confidentiality of logs that are not used in an investigation by the person in charge of support without obstructing the investigation by the person in charge of support.

[Hardware Configuration of Information Processing Apparatus]

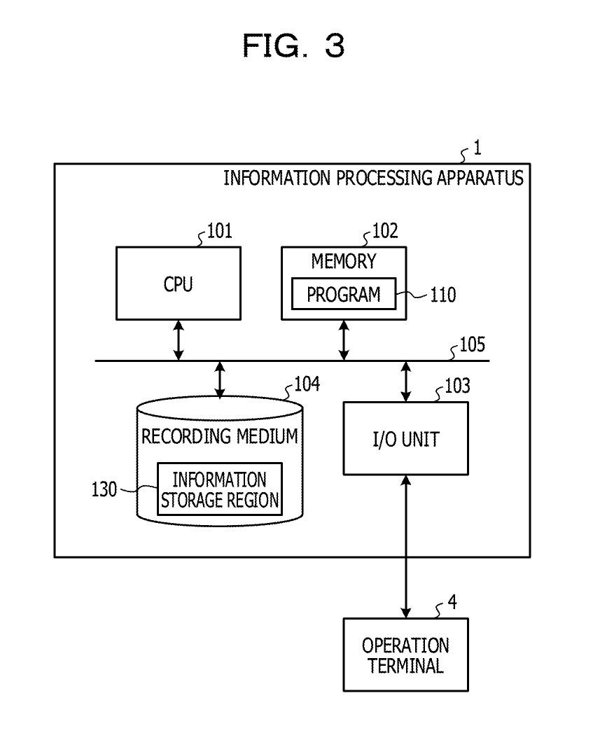

Now, a hardware configuration of the information processing apparatus 1 is described. FIG. 3 is a view depicting a hardware configuration of the information processing apparatus 1.

The information processing apparatus 1 includes a CPU 101 that is a processor, a memory 102, an external interface (input/output (I/O) unit) 103 and a recording medium 104. The components mentioned are coupled to each other through a bus 105.

The recording medium 104 stores, for example, in a program storage region (not depicted) thereof, a program 110 for performing a process for outputting a concealed log (hereinafter referred to also as log outputting process). Further, the storage memory 104 includes an information storage region 130 (hereinafter referred to also as storage unit 130) for storing information to be used, for example, when a log outputting process is performed. It is to be noted that the information storage region 130 corresponds to the storage device 1a depicted in FIG. 1 and so forth.

The CPU 101 loads, upon execution of the program 110, the program 110 from the recording medium 104 into the memory 102 and cooperates with the program 110 to perform a log outputting process. Further, the external interface 103 performs communication, for example, with the operation terminal 4.

[Functions of Information Processing Apparatus]

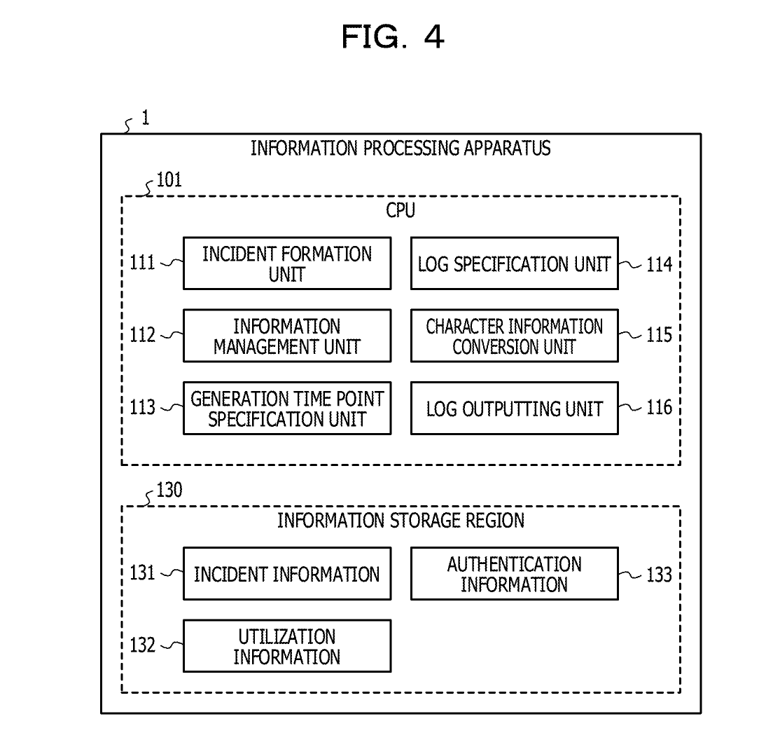

Now, functions of the information processing apparatus 1 are described. FIG. 4 is a functional block diagram of the information processing apparatus 1.

The CPU 101 of the information processing apparatus 1 cooperates with the program 110 to operate, for example, as an incident formation unit 111, an information management unit 112, a generation time point specification unit 113, a log specification unit 114, a character information conversion unit 115 and a log outputting unit 116. Then, into the information storage region 130, for example, incident information 131, utilization information 132 and authentication information 133 are stored.

The incident formation unit 111 forms incident information 131 from the substance of an inquiry (incident) inputted, for example, from the operation terminal 4. Then, the information management unit 112 stores the incident information 131 formed by the incident formation unit 111 into the information storage region 130.

The generation time point specification unit 113 specifies a generation time point of an incident of an investigation target. For example, the generation time point specification unit 113 specifies a generation time point included in the incident information 131 including information relating to the incident of the investigation target from within the incident information 131 stored in the information storage region 130.

The log specification unit 114 refers to the storage device 2a to specify first logs acquired within a period according to the generation time point specified by the generation time point specification unit 113 from among the plurality of logs included in the log information 231. The period according to the generation time point is, for example, a period from a time point prior by a given time period to the generation time point specified by the generation time point specification unit 113 (for example, priory by 10 minutes) to a time point later by a given time period than the generation time point specified by the generation time point specification unit 113 (for example, later by 10 minutes). Further, the log specification unit 114 refers to the storage device 2a to specify second logs acquired with any period other than the period according to the generation time point specified by the generation time point specification unit 113 from among the plurality of logs included in the log information 231.

The character information conversion unit 115 converts character information included in the first logs specified by the log specification unit 114 into first character information having higher confidentiality than confidentiality of the character information. Further, the character information conversion unit 115 converts character information included in the second logs specified by the log specification unit 114 into second character information having higher confidentiality than confidentiality of the first character information.

The log outputting unit 116 outputs log information 231a obtained by the conversion of the character information included in the first logs and the second logs. The utilization information 132 and the authentication information 133 are hereinafter described.

### First Embodiment

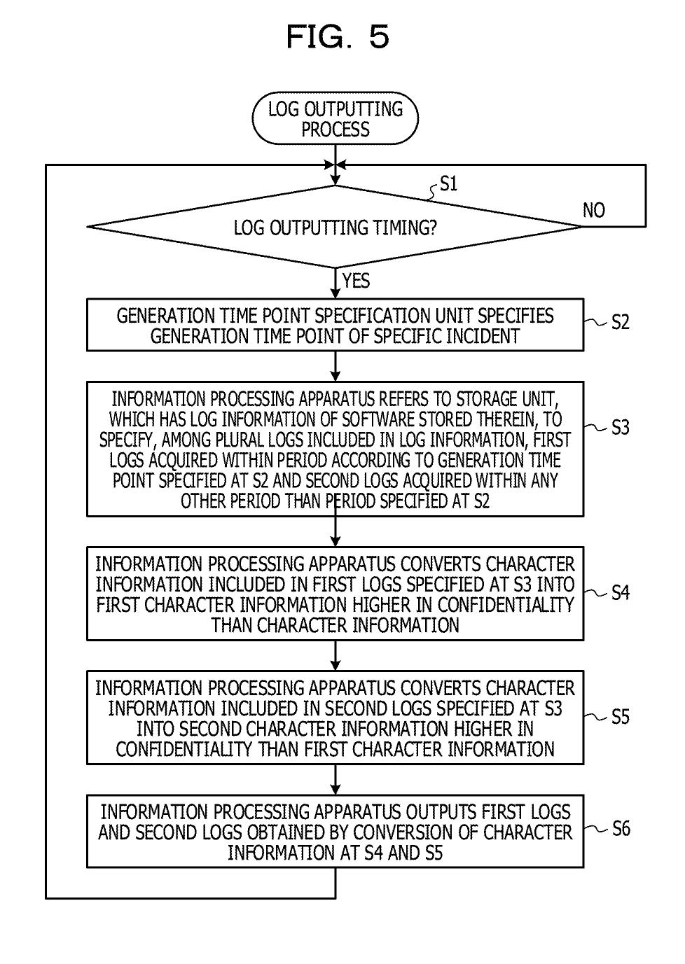

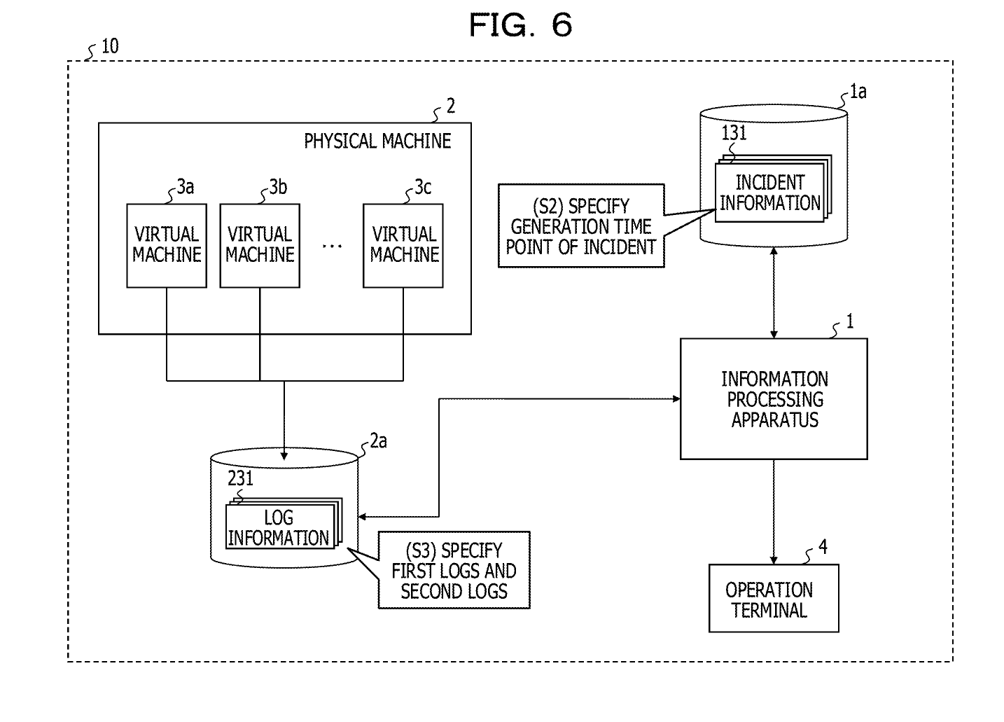

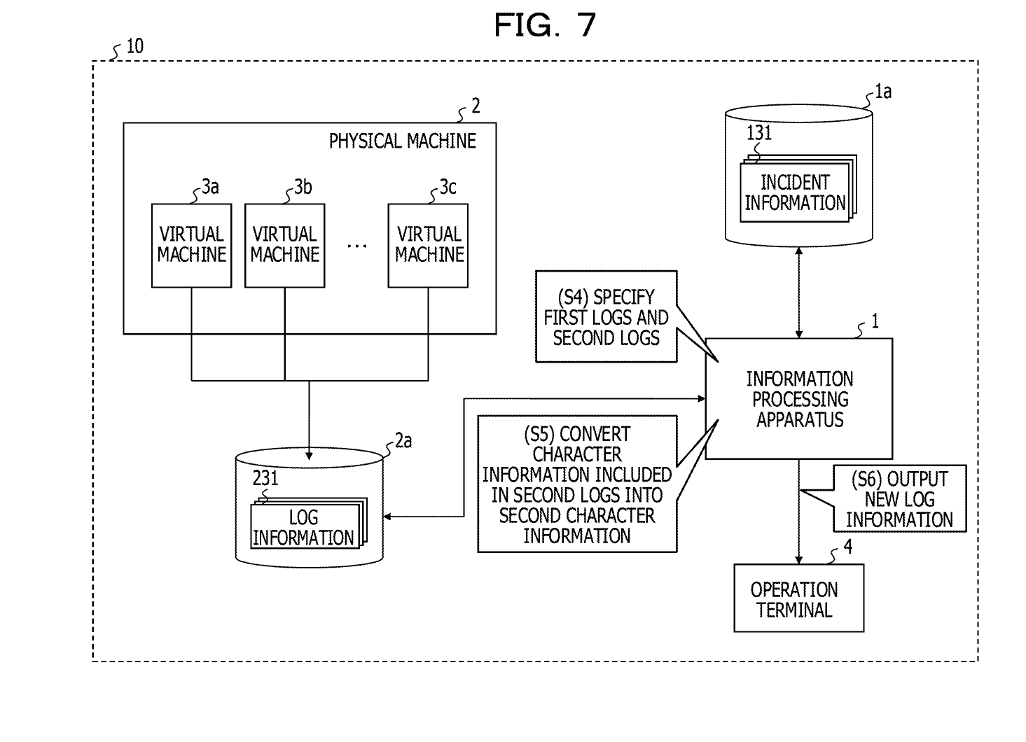

Now, an outline of a first embodiment is described. FIG. 5 is a flow chart illustrating an outline of a log outputting process in the first embodiment. Meanwhile, FIGS. 6 and 7 are views illustrating an outline of the log outputting process in the first embodiment. Details of the log outputting process of FIG. 5 are described with reference to FIGS. 6 and 7.

As depicted in FIG. 5, the information processing apparatus 1 waits until a log outputting timing comes (NO at S1). The log outputting timing may be, for example, a timing at which the person in charge of support performs inputting that an investigation of an incident is to be conducted through the operation terminal 4.

Then, when a log outputting timing comes (YES at S1), the information processing apparatus 1 specifies a generation time point of a specific incident as depicted in FIG. 6 (S2). The specific incident is an incident (incident of the investigation target) about which, for example, the person in charge of support has performed inputting to conduct an investigation through the operation terminal 4. For example, in the process at S2, the information processing apparatus 1 specifies a generation time point included, from within the incident information 131 stored in the information storage region 130, in the incident information 131 including information relating to the specific incident.

Then, as depicted in FIG. 6, the information processing apparatus 1 refers to the storage device 2a, which has the log information 231 of software stored therein, to specify, among a plurality of logs included in the log information 231, first logs acquired within a period according to the generation time point specified by the process at S2 and second logs acquired within any other period than the period specified by the process at S2 (S3).

Further, as depicted in FIG. 7, the information processing apparatus 1 converts character information included in the first logs specified by the process at S3 into first character information having higher confidentiality than confidentiality of the character information (S4). Further, the information processing apparatus 1 converts character information included in the second logs specified by the process at S3 into second character information having higher confidentiality than confidentiality of the first character information (S5) as depicted in FIG. 7.

For example, a log used in an investigation of an incident of an investigation target has high possibility that it may have been outputted at a time point close to the generation time point of the incident of the investigation target. Therefore, the information processing apparatus 1 performs concealment of the logs included in the log information 231 such that the confidentiality of a log outputted at a time point close to the generation time point of the incident of the investigation target becomes lower than the confidentiality of any other log.

Then, the information processing apparatus 1 outputs the first logs and the second logs (log information 231a) obtained by the conversion of the character information at S4 and S5 as depicted in FIG. 7 (S6).

This makes it possible for the information processing apparatus 1 to make the confidentiality of a log, which has high possibility in use in the investigation, relatively low and make the confidentiality of a log, which has low possibility in use in the investigation, relatively high. Therefore, the information processing apparatus 1 may maintain the confidentiality of logs that are not used in an investigation by the person in charge of support without obstructing the investigation by the person in charge of support.

### Details of First Embodiment

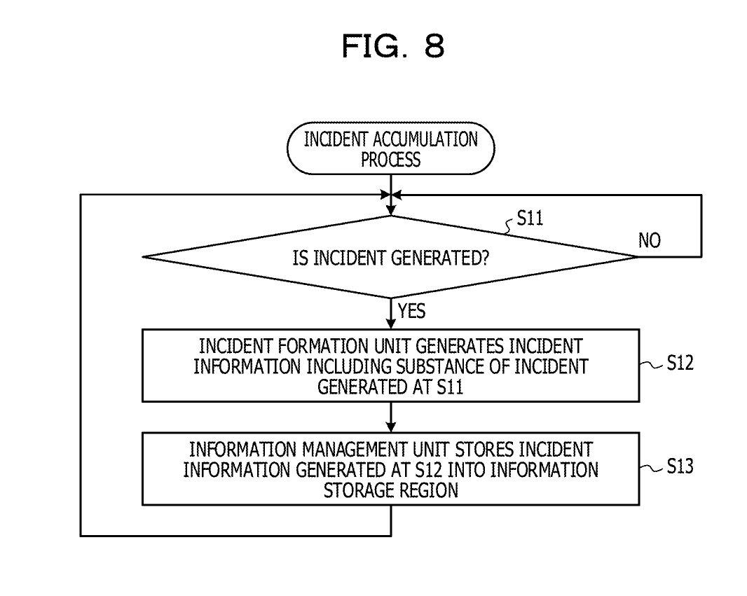

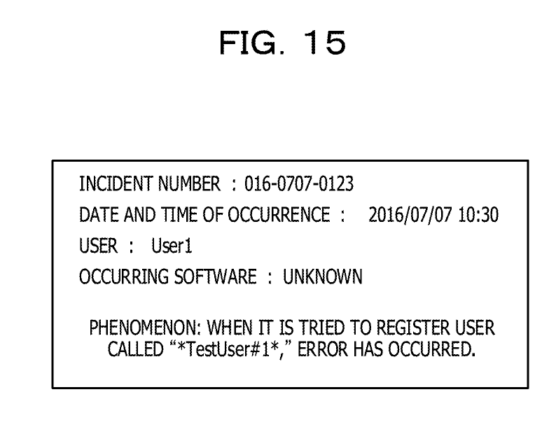

Now, details of the first embodiment are described. FIGS. 8 to 14 are flow charts illustrating details of the log outputting process in the first embodiment. Meanwhile, FIGS. 15 to 27 are views illustrating details of the log outputting process in the first embodiment. Details of the log outputting process of FIGS. 8 to 14 are described with reference to FIGS. 15 to 27.

First, a process for performing accumulation of incident information 131 (hereinafter referred to also as incident accumulation process) from within the log outputting process is described. FIG. 8 is a flow chart illustrating the incident accumulation process.

As depicted in FIG. 8, the incident formation unit 111 of the information processing apparatus 1 waits until a new incident occurs (NO at S11). For example, the incident formation unit 111 waits, for example, until the substance of an inquiry (incident) is inputted through the operation terminal 4 by the person in charge of support.

Then, if a new incident occurs (YES at S11), the incident formation unit 111 forms incident information 131 including the substance of the incident having occurred by the process at S11 (S12). Thereafter, the information management unit 112 of the information processing apparatus 1 stores the incident information 131 formed by the process at S12 into the information storage region 130 (S13). In the following, a particular example of the incident information 131 is described.

[Particular Example of Incident Information]

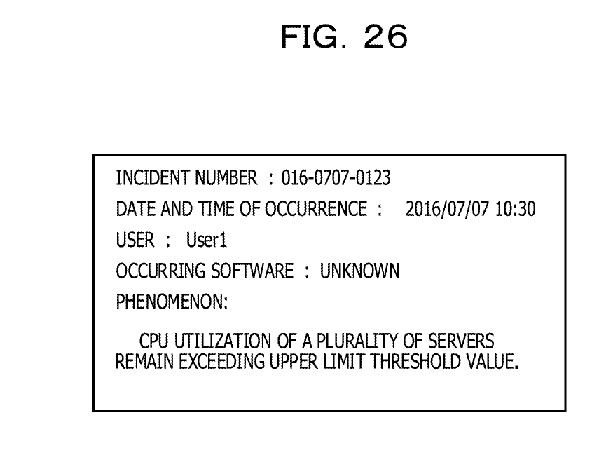

FIGS. 15 and 26 are views illustrating particular examples of the incident information 131. The incident information 131 depicted in FIG. 15 and so forth is incident information 131 relating to a certain one incident and is part of incident information 131 stored in the information storage region 130.

Further, the incident information 131 depicted in FIG. 15 and so forth includes “incident number” that is a number for identifying each incident, “date and time of occurrence” that is a time point at which each incident has occurred, and “user” that is identification information of a user by which an inquiry has been issued to the person in charge of support. Further, the incident information 131 depicted in FIG. 15 includes “occurring software” that is software corresponding to the substance of the inquiry and “phenomenon” that is the substance of the inquiry.

For example, in the incident information 131 depicted in FIG. 15, “016-0707-0123” is set as “incident number”; “2016/07/07 10:30” is set as “date and time of occurrence”; and “User1” is set as “user.” Further, in the incident information 131 depicted in FIG. 15, “unknown” is set as “occurring software,” and as “phenomenon,” the substance “that, when it is tried to register a user called “*TestUser#1*,” an error has occurred” is set. It is to be noted that each piece of information included in the incident information 131 depicted in FIG. 15 is, for example, information inputted to the operation terminal 4 by the person in charge of support who has accepted the inquiry.

Referring back to FIG. 8, the incident formation unit 111 waits until a next incident occurs after the process at S13 (NO at S11).

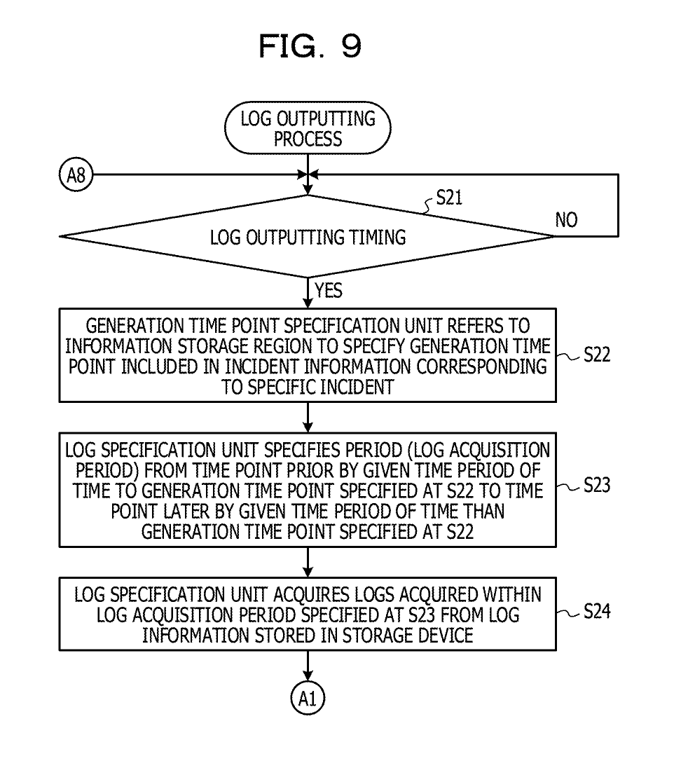

Now, the log outputting process other than the incident accumulation process is described. FIGS. 9 to 14 are flow charts illustrating the log outputting process other than the incident accumulation process.

The generation time point specification unit 113 of the information processing apparatus 1 waits until a log outputting timing comes as depicted in FIG. 9 (NO at S21). Then, when a log outputting timing comes (YES at S21), the generation time specification unit 113 of the information processing apparatus 1 refers to the incident information 131 stored in the information storage region 130 to specify the generation time point included in the incident information 131 corresponding to the specific incident (S22).

For example, in “date and time of occurrence” of the incident information 131 depicted in FIG. 15, “10:30” that is the generation time point of the incident is included. Therefore, the generation time point specification unit 113 refers to the incident information 131 depicted, for example, in FIG. 15 to specify “10:30” as the date and time of occurrence corresponding to the specific incident.

Thereafter, the log specification unit 114 of the information processing apparatus 1 specifies a period from a time point prior by a given time period to the generation time point specified by the process at S22 to another time point later by a given time period than the generation time point specified by the process at S22 (S23).

For example, when the generation time point specified by the process at S22 is “10:30,” the log specification unit 114 specifies the period from a time point (10:20) prior by 10 minutes to the specified generation time point to a time point (10:40) later by 10 minutes than the specified generation time point as a log acquisition period.

Then log specification unit 114 acquires the logs acquired within the log acquisition period specified by the process at S23 from the log information 231 stored in the storage device 2a (S24). In the following, a particular example of the log information 231 stored in the storage device 2a is described.

[Particular Example of Log Information]

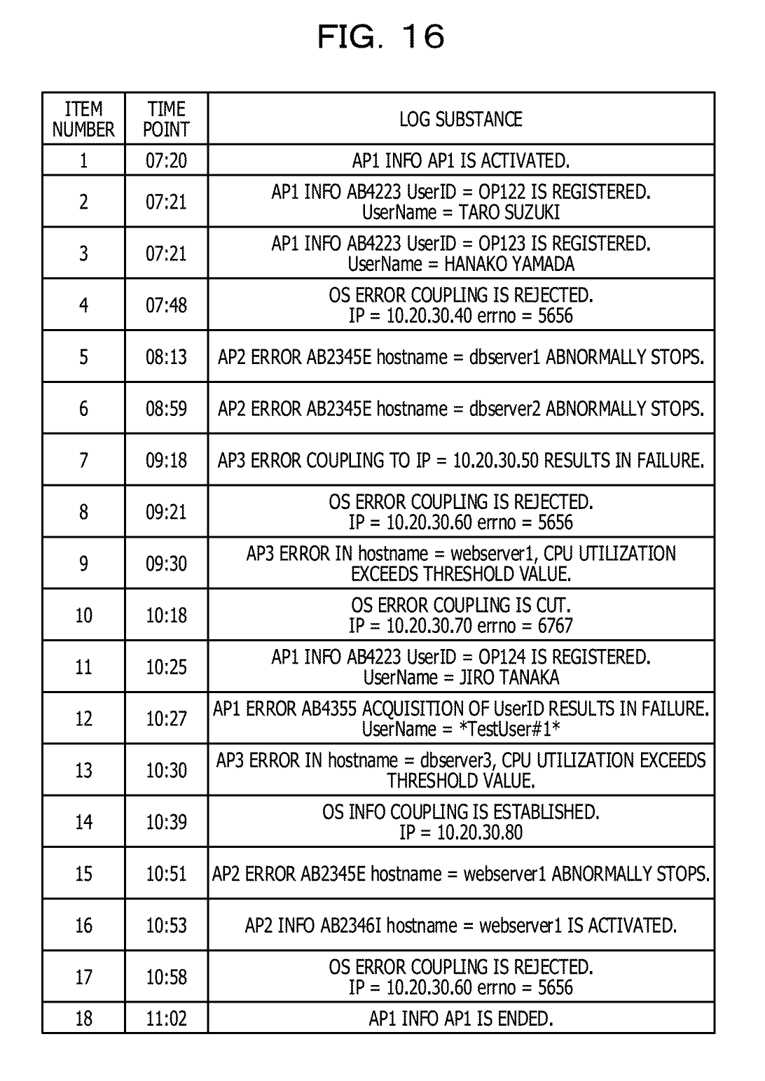

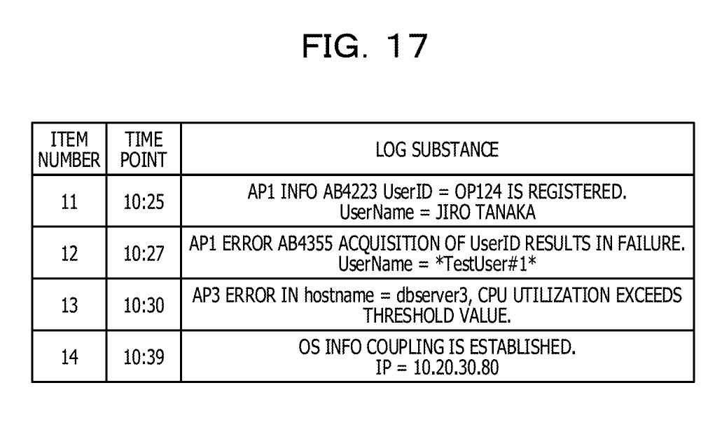

FIG. 16 is a view illustrating a particular example of the log information 231 stored in the storage device 2a. Further, FIGS. 17, 18, 20, 22, 23, 24, 25 and 27 are views illustrating particular examples of logs acquired from the log information 231 stored in the storage device 2a.

The log information 231 and so forth depicted in FIG. 16 include, as items, “item number” for specifying each log, “time point” to which a time point at which each log was acquired (such time point is hereinafter referred to also as formation time point) is set, and “log substance” to which the substance of each log is set.

In the log information 231 and so forth depicted in FIG. 16, in “log substance,” character information of one of “AP1,” “AP2,” “AP3” and “OS” is included as information for identifying software in which an event indicated by the substance of each log has occurred. “AP1,” “AP2” and “AP3” are character information each representative of a piece of software, and “OS” is character information indicative of the operating system (OS) on which each piece of software operates.

Further, in the log information 231 depicted in FIG. 16, in “log information,” character information of one of “ERROR” indicating that an abnormal situation occurs and “INFO” indicating that no abnormal situation occurs is included as information for identifying a type of an event indicated by the substance of each log.

For example, to a log whose “item number” is “1,” “07:20” is set as “time point,” and as “log substance,” the substance that “AP1 INFO AP1 is activated.” is set as “log substance.” Meanwhile, to a log whose “item number” is “4,” “07:48” is set as “time point,” and “OS ERROR coupling is rejected. IP=10.20.30.40, errno=5656” is set as “log substance.” Description of the other pieces of information included in FIG. 16 is omitted.

Then, the log specification unit 114 acquires, in the process at S24, logs whose time point set to “time point” is included in the log acquisition period specified by the process at S23, for example, from the logs included in the log information 231 depicted in FIG. 16. For example, where the log acquisition period is a period from “10:20” to “10:40,” the log specification unit 114 acquires logs whose “item number” is “11” to “14” from the log information 231 depicted in FIG. 16 as depicted in FIG. 17.

Consequently, the log specification unit 114 may extract logs that are used with a high degree of possibility when an investigation for an inquiry accepted by the person in charge of support is conducted.

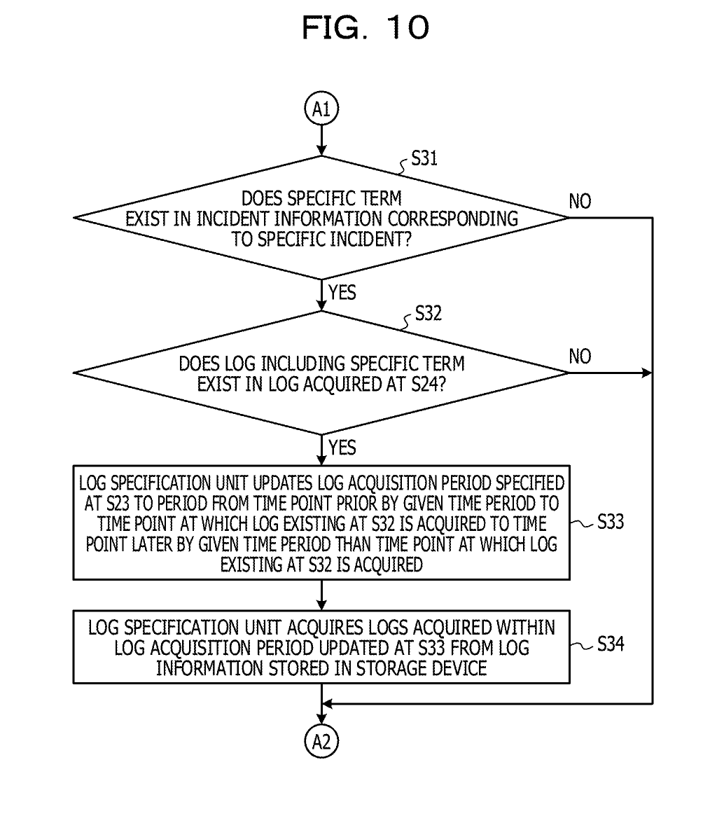

Referring back to FIG. 10, the log specification unit 114 decides whether or not a specific term is included in the incident information 131 corresponding to a specific indent (S31). The specific term is, for example, character information configured from a noun other than general terms and included in a sentence set in “phenomenon” of the incident information 131.

For example, the log specification unit 114 performs morphological division, for example, for character information set in “phenomenon” of the specific incident information 131 and specifies “*TestUser#1*,” “user,” “registration,” “error” and “occurrence.” Here, “user,” “registration,” “error” and “occurrence” are general terms. Therefore, the log specification unit 114 decides that “*TestUser#1*” that is a specific term exists in the incident information 131 corresponding to the specific incident.

Then, if it is decided that a specific term is included in particular incident information 131 (YES at S31), the log specification unit 114 decides whether or not a log including a specific term exists in the logs acquired by the process at S24 (S32).

As a result, if it is decided that a log including a specific term exists in the logs acquired by the process at S24 (YES at S32), the log specification unit 114 updates the log acquisition period specified by the process at S23 to a period from a time point prior by a given time period to the time point at which the log decided to exist by the process at S32 is acquired to another time point later by a given time period than the time point at which the log decided to exist by the process at S32 is acquired (S33).

For example, in “log substance” of the log whose “item number” is 12 among the logs depicted in FIG. 17, the character information of “*TestUser#1*” is included. Further, to “time” of the log whose “item number” is “12,” “10:27” is set. Therefore, the log specification unit 114 in this instance updates the log acquisition period to a period from “10:17” to “10:37.”

For example, each piece of information included in the incident information 131 is, for example, information extracted and set from the substance of an inquiry from a user by the person in charge of support (for example, the substance of a mail transmitted from the user). Therefore, in some cases, each piece of information included in the incident information 131 is not necessarily accurate. Therefore, if a log including a specific term included in “phenomenon” of the incident information 131 exists, the log specification unit 114 decides that the log is a log corresponding to the substance of the inquiry accepted from the user. Then, the log specification unit 114 decides that an event corresponding to the substance of the inquiry accepted from the user occurred at the time point set in “time point” of the existing log and performs updating of the log acquisition period.

Consequently, the log specification unit 114 may extract a log, which has high possibility that it may be used when an investigation for an inquiry accepted by the person in charge of support is to be conducted, with a higher efficiency.

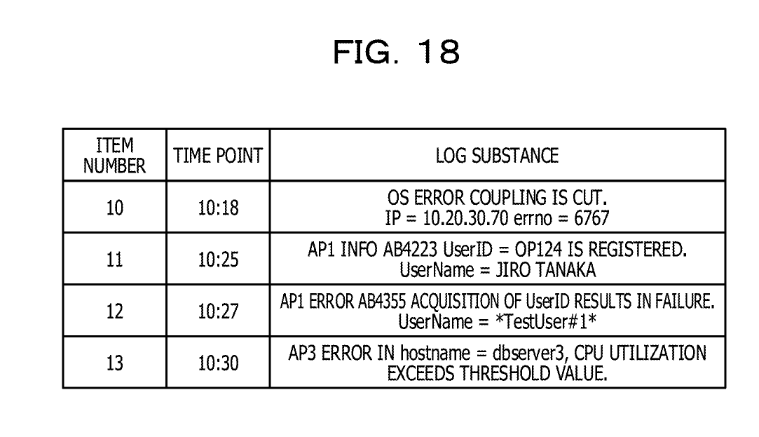

Thereafter, the log specification unit 114 acquires logs acquired within the log acquisition period updated by the process at S33 from the log information 231 stored in the storage device 2a (S34). For example, when the log acquisition period is updated to a period from “10:17” to “10:37,” the log specification unit 114 acquires logs having “item number” set to “10” to “13” from the log information 231 depicted in FIG. 16 as depicted in FIG. 18.

On the other hand, if it is decided that no specific term is included in the incident information 131 (NO at S31) or if it is decided that a log including a specific term does not exist in the logs acquired by the process at S24 (NO at S32), the log specification unit 114 does not perform the processes at S33 and S34. For example, in those cases, the log specification unit 114 fails to perform specification of a log corresponding to the substance of the inquiry accepted from the user, and therefore, the log specification unit 114 does not perform updating of the log acquisition period and so forth.

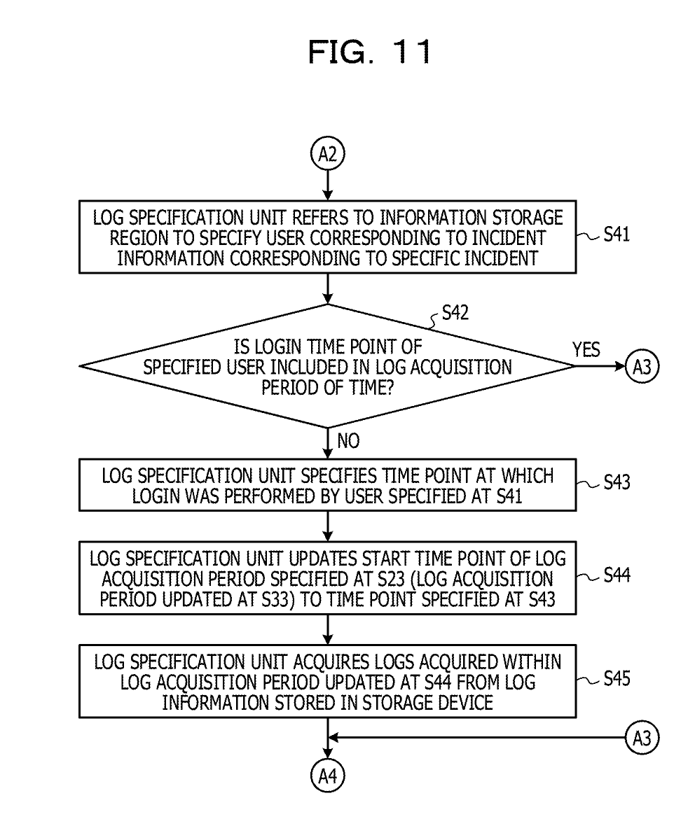

Thereafter, as depicted in FIG. 11, the log specification unit 114 refers to the incident information 131 stored in the information storage region 130 to specify a user corresponding to the incident information 131 corresponding to the specific incident (S41). For example, the log specification unit 114 refers, for example, to the incident information 131 described hereinabove with reference to FIG. 15 to specify “User1” that is information set to “user.”

Then, the log specification unit 114 decides whether or not the time point at which login was performed by the user specified by the process at S41 is included in the log acquisition time period specified by the process at S23 (log acquisition period updated by the process at S33) (S42). If it is decided as a result that the time point at which login was performed by the user specified by the process at S41 is not included in the log acquisition period (NO at S42), the log specification unit 114 specifies the time point at which login was performed by the user specified by the process at S41 (S43).

For example, the log specification unit 114 refers to the authentication information 133 stored in the information storage region 130 to specify the time point at which login was performed by the user specified by the process at S41. The authentication information 133 is, for example, information indicative of a time point at which each user performed login or logout to or from each piece of software (software operating on the virtual machine 3). It is to be noted that, where the user specified by the process at S41 has performed login to each of a plurality of pieces of software, the log specification unit 114 may specify a time point earliest among time points at which the user specified by the process at S41 performed login. In the following, a particular example of the authentication information 133 is described.

[Particular Example of Authentication Information]

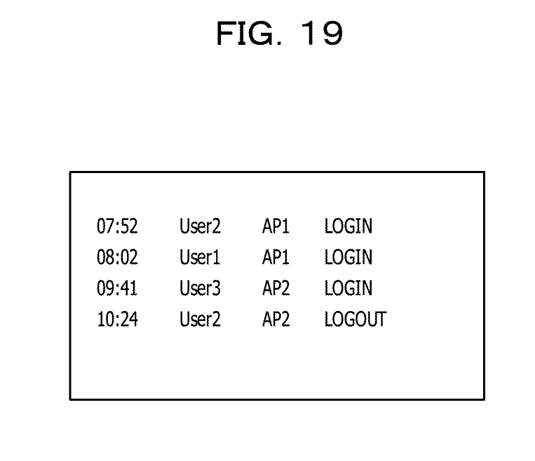

FIG. 19 is a view illustrating a particular example of the authentication information 133. In the authentication information 133 depicted in FIG. 19, information with which “07:52,” “User2,” “AP1” and “login” are associated is included. For example, in the authentication information 133 depicted in FIG. 19, information representing that User2 performed login to AP1 at “07:52.” Further, in the authentication information 133 depicted in FIG. 19, information with which “08:02,” “User1,” “AP1” and “login” are associated is included. In other words, in the authentication information 133 depicted in FIG. 19, information representing that User1 performed login to AP1 at “08:02” is included. Description of the other information included in FIG. 19 is omitted.

Then, when the log acquisition period specified by the process at S23 (log acquisition period updated by the process at S33) is a period from “10:17” to “10:37,” “08:02” that is the time point at which User1 performed login is not included in the log acquisition period. Therefore, the log specification unit 114 specifies, for example, in the process at S43, “08:02” that is the time period at which User1 performed login.

Referring back to FIG. 11, the log specification unit 114 updates the start time point of the log acquisition period specified by the process at S23 (log acquisition period updated by the process at S33) to the time point specified by the process at S43 (S44). For example, where the log acquisition period is a period from “10:17” to “10:37” and the time point at which User1 performed login is “08:02,” the log specification unit 114 updates the log acquisition period to the period from “08:02” to “10:37.”

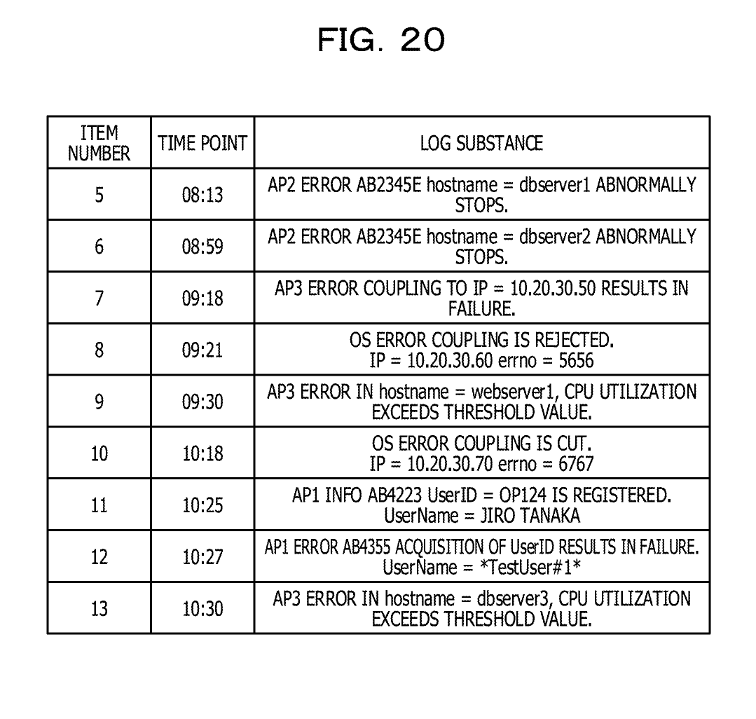

Then, the log specification unit 114 acquires the logs acquired within the log acquisition period updated by the process at S44 from the log information 231 stored in the storage device 2a (S45). For example, when the log acquisition period is updated to the period from “08:02” to “10:37,” the log specification unit 114 acquires logs having “5” to “13” in “item number” from the log information 231 depicted in FIG. 16 as depicted in FIG. 20.

For example, there is the possibility that a period to be used when an investigation for an inquiry accepted by the person in charge of support may be included within a period after the user who issued the inquiry performed login. Therefore, when the time point at which the user who issued the inquiry performed login to one of pieces of software is prior to the log acquisition time point, the log specification unit 114 advances the start time point such that the login time point is included in the log acquisition time period.

This makes it possible for the log specification unit 114 to extract a log, which is used with a high degree of possibility when an investigation for an inquiry accepted by the person in charge of support is conducted, in higher efficiency.

It is to be noted that, when it is decided that the time point at which login was performed by the user specified by the process at S41 is included in the log acquisition period (YES at S42), the log specification unit 114 does not perform the processes from S43 to S45. For example, in this case, since the log specification unit 114 need not update the start time point of the log acquisition period to a time point before this, the log specification unit 114 does not perform updating or the like of the log acquisition period.

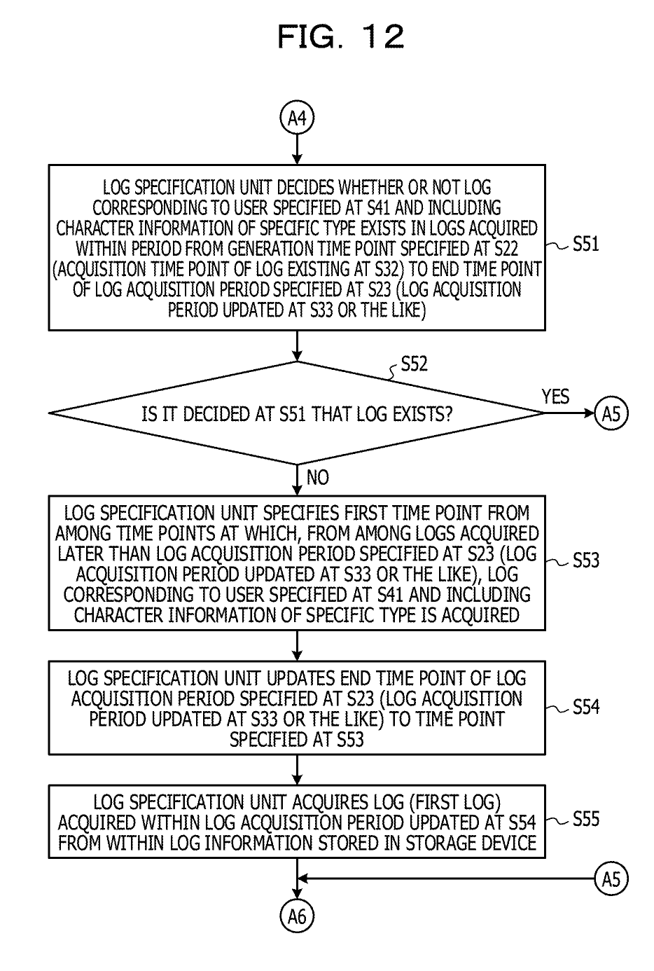

Thereafter, the log specification unit 114 specifies logs acquired within a period from the generation time point specified by the process at S22 (time point at which the log existing by the process at S32 was acquired) to the end time point of the log acquisition period specified by the process at S23 (log acquisition period updated by the process at S33 or the like) from among the logs acquired by the process at S24, S34 or S45 as depicted in FIG. 12. Then, the log specification unit 114 decides whether or not a log corresponding to the user specified by the process at S41 and including character information of a specific type exists in the specified logs (S51). The character information of the specific type is, for example, character information configured from “ERROR.”

For example, the log specification unit 114 refers, for example, to the utilization information 132 stored in the information storage region 130 to specify a piece of software utilized by the user specified by the process at S41. Then, the log specification unit 114 specifies, for example, a log to whose “substance of log” character information including the character information indicative of the specified piece of software and the character information configured from “ERROR” is set. In the following, a particular example of the utilization information 132 is described.

[Particular Example of Utilization Information]

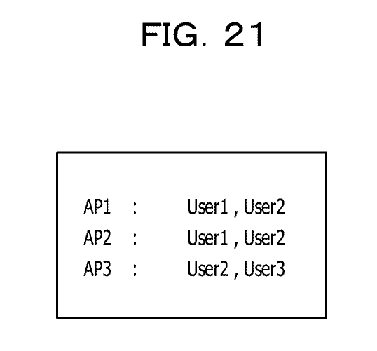

FIG. 21 is a view illustrating a particular example of the utilization information 132. The utilization information 132 depicted in FIG. 21 indicates that “User1” and “User2” are users who utilize “AP1”; “User1” and “User2” are users who utilize “AP2”; and “User2” and “User3” are users who utilize “AP3.”

Therefore, in the process at S51, when the information set to “user” of the incident information 131 described hereinabove with reference to FIG. 15 is “User1,” the log specification unit 114 specifies “AP1” and “AP2” as pieces of software utilized by “User1.”

Here, if the generation time point of an incident is “10:27” and the end time point of the log acquisition time period is “10:37,” only a log whose “item number” is “13” is a log to whose “time point” a point of time between the generation time point of the incident and the end time point of the log acquisition time period is set in the log information 231 depicted in FIG. 20. Further, while “log substance” of the log whose “item number” is “13” includes character information configured from “ERROR,” it does not include character information configured from “AP1,” “AP2” or “OS.” Therefore, in this case, the log specification unit 114 decides in the process at S51 that a log that satisfies the conditions does not exist (NO at S52).

Referring back to FIG. 12, if it is decided by the process at S51 that no log exists (NO at S52), the log specification unit 114 specifies the first time point from among time points at which, from among logs acquired later than the log acquisition period specified by the process at S23 (log acquisition period updated by the process at S33 or the like), a log corresponding to the user specified by the process at S41 and including the character information of the specific type is acquired (S53). Then, the log specification unit 114 updates the end time point of the log acquisition period specified by the process at S23 (log acquisition period updated by the process at S33 or S44) to the time point specified by the process at S53 (S54).

For example, the log specification unit 114 specifies logs whose “item number” is “15” and “17” as logs to whose “time point” a time point later than “10:37” that is the end time point of the log acquisition time period is set and in whose “log substance” character information including the character information configured from “AP1,” “AP2” or “OS” and the character information configured from “ERROR” is included, for example, from the log information 231 described hereinabove with reference to FIG. 16. Then, the log specification unit 114 specifies the log that is a log acquired first and whose “item number” is “15” from between the logs whose “item number” is “15” and “17.” Further, the log specification unit 114 updates “10:37” that is the end time point of the log acquisition time period to “10:51” set to “time point” of the log whose “item number” is “15.”

For example, there is the possibility that a log to be used when an investigation for an inquiry accepted by the person in charge of support is conducted may have been acquired at a time point later than the log acquisition time period specified by the process at S23 (log acquisition period updated by the process at S33 or the like). Further, a log that is used when an investigation is conducted includes the character information of “ERROR” indicating that an abnormal event has occurred with high possibility.

Therefore, when a log including the character information of “ERROR” does not exist in the logs acquired within a period from the generation time point of the incident and the end time point of the log acquisition time period from among the logs acquired within the log acquisition time period, the log specification unit 114 decides that there is the possibility that the log used when an investigation is performed may have been acquired after the log acquisition time period. Then, the log specification unit 114 in this case updates the end time point of the log acquisition time period to a time point at which the log acquired first is acquired from among the logs acquired after the log acquisition time period and including the character information configured from “AP1,” “AP2” or “OS” and the character information including “ERROR.”

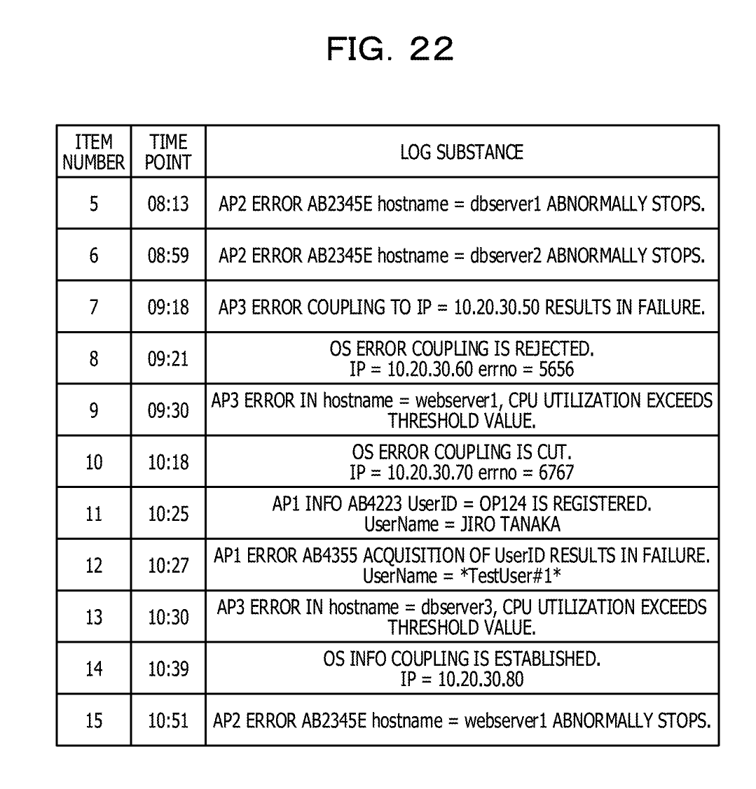

Thereafter, the log specification unit 114 acquires the logs (first logs) acquired within the log acquisition time period updated by the process at S54 from within the log information stored in the storage device 2a (S55). For example, when the log acquisition time period is updated to the period from “08:02” to “10:51,” the log specification unit 114 acquires logs to whose “item number” “5” to “15” are set from within the log information 231 depicted in FIG. 16 as depicted in FIG. 22.

On the other hand, if the log specification unit 114 decides in the process at S51 that a log exists (YES at S52), the log specification unit 114 does not perform the processes at S53, S54 and S55. For example, in this case, since there is no necessity to update the end time point of the log acquisition time period to a later time point, the log specification unit 114 does not perform updating and so forth of the log acquisition time period.

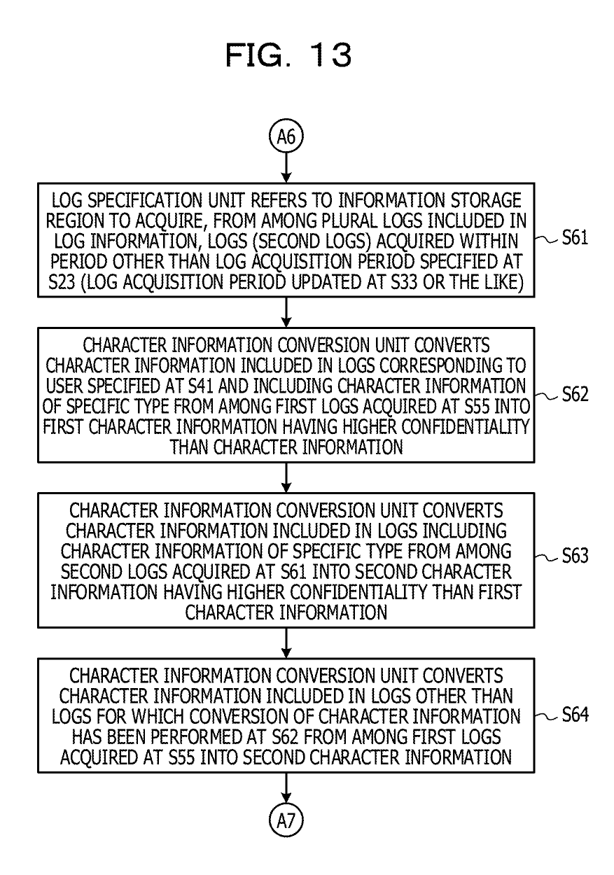

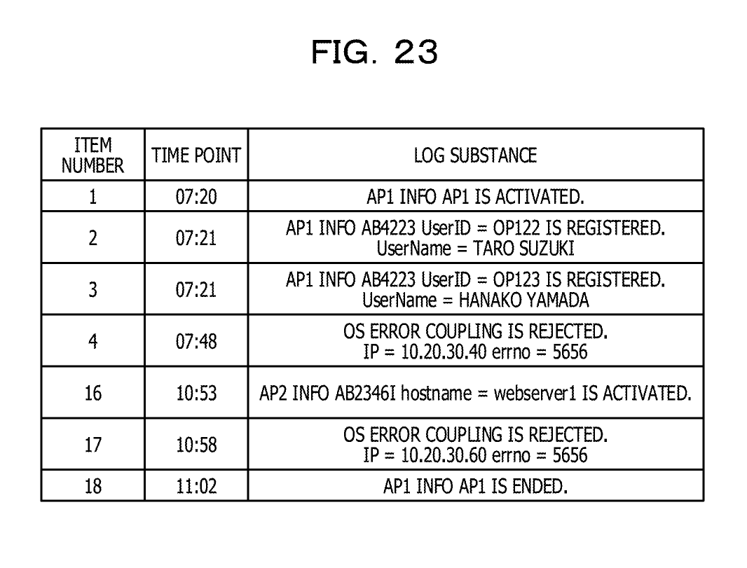

Then, as depicted in FIG. 13, the log specification unit 114 refers to the log information 231 stored in the information storage region 130 to acquire logs (second logs) acquired within any other period than the log acquisition time period specified by the process at S23 (log acquisition time period updated by the process at S33 or the like) from among the plurality of logs included in the log information 231 (S61). For example, the log specification unit 114 acquires logs other than the first logs described hereinabove with reference to FIG. 22 (logs whose “item number” is “1” to “4” and logs whose “item number” is “16” to “18”) from within the log information 231 described hereinabove with reference to FIG. 16 as second logs as depicted in FIG. 23.

It is to be noted that the log specification unit 114 may acquire only part of the logs other than the first logs from within the log information 231 stored in the storage device 2a as second logs. For example, the log specification unit 114 may acquire, as second logs, for example, logs other than the first logs from among logs acquired within a period from a time point prior by a given time period (for example, by one hour) to the generation time point specified by the process at S22 (time point at which the log existing by the process at S32 is acquired) to a time point later by a given time period than the generation time point (for example, later by one hour).

Thereafter, the character information conversion unit 115 of the information processing apparatus 1 converts character information included in logs corresponding to the user specified by the process at S41 and including character information of a specific type from among the first logs acquired by the process at S55 into first character information having confidentiality higher than confidentiality of the character information (S62).

Further, the character information conversion unit 115 converts character information included in the logs including the character information of the specific type from among the second logs acquired by the process at S61 into second character information having confidentiality higher than confidentiality of the first character information (S63). Further, the character information conversion unit 115 converts character information included in the logs other than the logs for which conversion of character information has been performed by the process at S62 from among the first logs acquired by the process at S55 into second character information (S64). In the following, logs after character information of the same is converted by the processes at S62 to S64 are described.

[Particular Example (1) of Log after Conversion of Character Information]

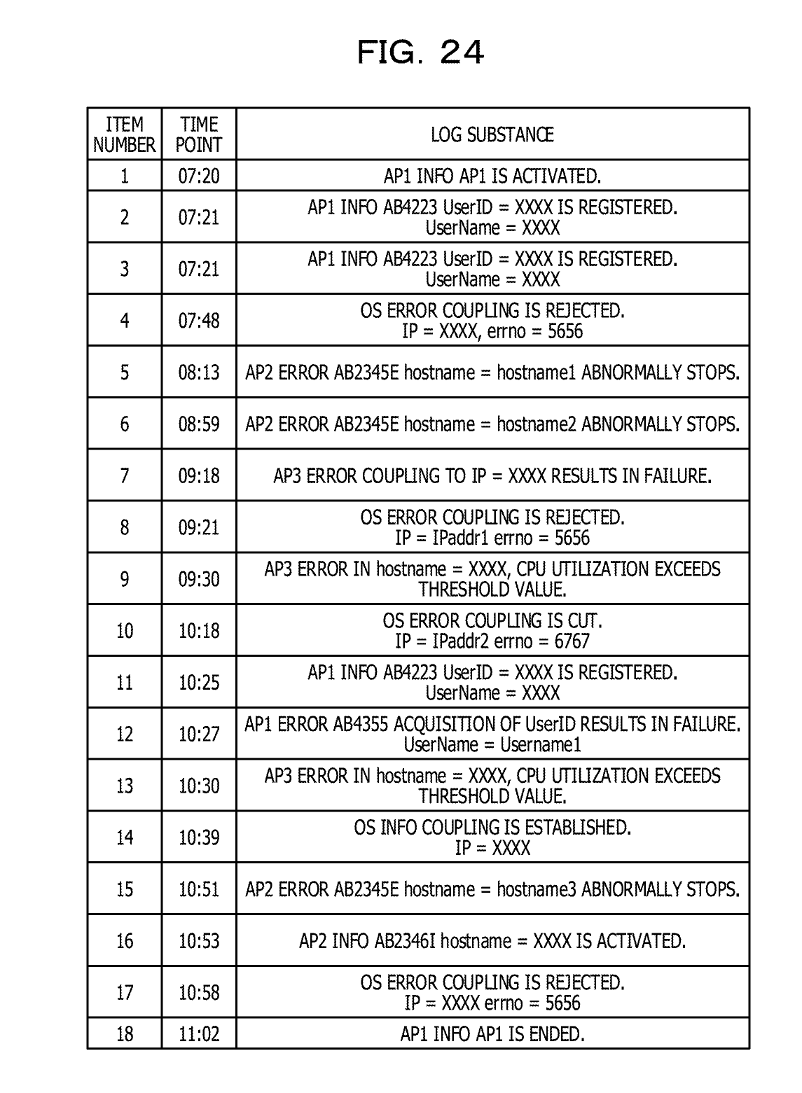

FIG. 24 is a view illustrating a particular example of logs after character information of the same is converted by the processes at S62 to S64. From among the logs depicted in FIG. 24, the logs whose “item number” is “1” to “4” and the logs whose “item number” is “16” to “18” are logs after character information included in the second logs depicted in FIG. 23 are converted (S63). Further, the logs whose “item number” is “5” to “15” from among the logs depicted in FIG. 24 are logs after character information included in the first logs depicted in FIG. 22 is converted (S62 and S64).

In the following description, it is assumed that conversion into second character information is performed by converting all character information of a conversion target into “XXXX.” Further, it is assumed that conversion into first character information is performed, where the character information of the conversion target is an IP address, by converting it into “IPaddr1,” but where the character information of the conversion target is a user name, by converting it into “Username1.” Further, conversion into first character information is performed, where the character information of the conversion target is a host name, by converting it into “hostname1.” It is to be noted that, in order to ensure the uniqueness of character information before conversion also after the conversion, the “1” at the tail end changes for every piece of character information before the conversion.

Further, it is assumed that conversion into third character information is performed by converting, without changing the number of characters of character information of the conversion target, a numeral included in the character information of the conversion target into “1,” converting an upper case into “A,” converting a lower case into “a,” and converting a symbol into “*.” If the conversion target is in Japanese, for example, a hiragana, a katakana, kanji, and a two-byte-symbol is converted into one character of hiragana, one character of katakana, one character of kanji, and one character of two-byte-symbol for each. It is to be noted that, in order to ensure the uniqueness of character information before conversion also after the conversion, one character at the tail end made different for every piece of character information.

For example, the logs that include the character information configured from “AP1,” “AP2” or “OS” that is software utilized by the user specified by the process at S41 and the character information configured from “ERROR” from among the first logs depicted in FIG. 24 (logs whose “item number” is “5” to “15”) are logs whose “item number” is “5,” “6,” “8,” “10,” “12” and “15.”

Therefore, the character information conversion unit 115 converts, for example, character information following “hostname=” from within the information set in “log substance” of the log whose “item number” in the log information 231 described hereinabove with reference to FIG. 16 is “5” is converted into from “dbserver1” into “hostname1” that is the first character information as indicated by an underlined portion in FIG. 24. Further, the character information conversion unit 115 converts, for example, character information following “hostname=” from within the information set in “log substance” of the log whose “item number” is “6” in the log information 231 described hereinabove with reference to FIG. 16 from “dbserver2” to “hostname2” that is the first character information. Furthermore, the character information conversion unit 115 converts, for example, character information following “IP=” in the information set in “log information” of the log whose “item number” is “8” in the log information 231 described hereinabove with reference to FIG. 16 from “10.20.30.60” into “IPaddr1” that is the first character information.

Meanwhile, the logs that do not include any of the character information configured from “AP1,” “AP2” or “OS” that is software utilized by the user specified by the process at S41 and the character information configured from “ERROR” from among the first logs depicted in FIG. 24 (logs whose “item number” is “5” to “15”) are logs whose “item number” is “7,” “9,” “11,” “13” and “14.” Further, the second logs depicted in FIG. 24 are logs whose “item number” is “1” to “4” and whose “item number” is “16” to “18.”

Therefore, as indicated by an underlined portion of FIG. 24, the character information conversion unit 115 converts, for example, character information following “IP=” from within information set to “log substance” of the log whose “item number” is “7” in the log information 231 described hereinabove with reference to FIG. 16 is converted from “10.20.30.50” into “XXXX” that is second character information. Further, the character information conversion unit 115 converts, for example, character information following “IP=” from within information set to “log substance” of the log whose “item number” is “14” in the log information 231 described hereinabove with reference to FIG. 16 from “10.20.30.60” into “XXXX” that is second character information.

For example, the first logs are logs acquired at time points close to the generation time point of the incident of the investigation target. Then, it may be decided that, from among the first logs, a log relating to software utilized by the user from which an inquiry has been issued to the person in charge of support is a log having high possibility that it may be used in an investigation of the incident of the investigation target.

Therefore, the character information conversion unit 115 makes the confidentiality of the log relating to the software utilized by the user specified by the process at S41 from among the first logs lower than the confidentiality of logs relating to software utilized by any other user than the user specified by the process at S41 from among the first logs. Similarly, the character information conversion unit 115 makes the confidentiality of the log relating to the software utilized by the user specified by the process at S41 from among the first logs lower than the confidentiality of the second logs.

Consequently, the information processing apparatus 1 may set the confidentiality of a log, whose possibility that it may be utilized in an investigation is high, relatively low and set the confidentiality of a log, whose possibility that it may be used in an investigation is low, relatively high. Therefore, the information processing apparatus 1 may maintain the confidentiality of logs that are not used in an investigation by the person in charge of support without disturbing the investigation by the person in charge of support.

It is to be noted that the authentication information 133 described with reference to FIG. 19 does not include information indicating that User1 has logged in to AP2. Therefore, the information processing apparatus 1 may decide that a log that includes character information configured from “AP2” is a log whose possibility that it may be used when an investigation for an inquiry is conducted is low. Then, in this case, the character information conversion unit 115 may convert character information included in a log including character information configured from “AP2” from among the first logs into second character information (S62 and S64).

This makes it possible for the character information conversion unit 115 to further restrict logs whose confidentiality is to be set lower.

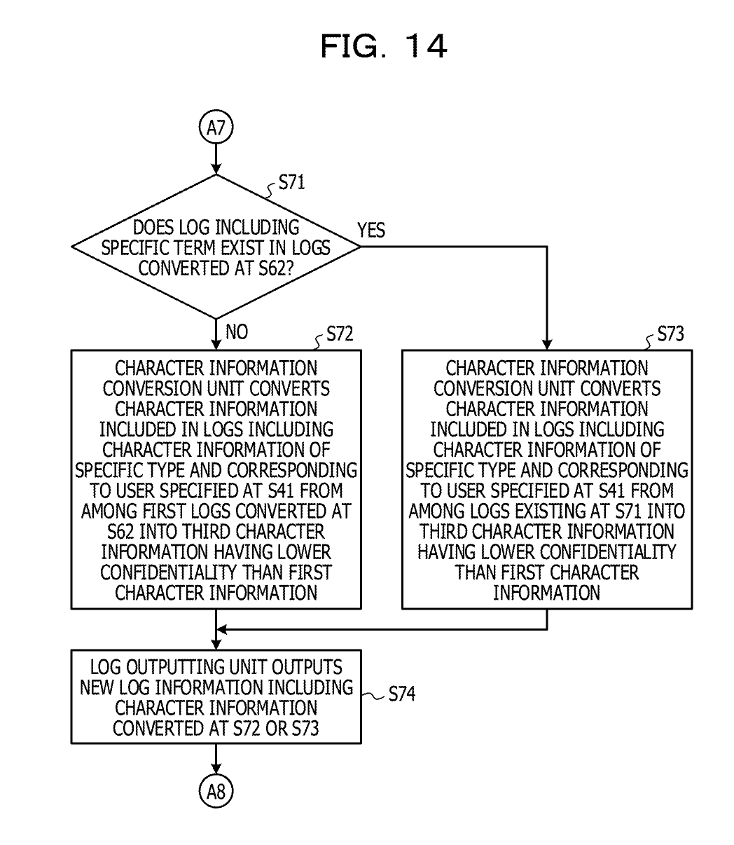

Then, the character information conversion unit 115 decides whether or not a log including a specific term exists in the logs converted by the process at S62 as depicted in FIG. 14 (S71). For example, the character information conversion unit 115 decides whether or not there exists, for example, a log including character information (for example, “*TestUser#1*”) for which the decision of whether or not it is included in the specific incident information 131 has been performed in the decision at S31.

If it is decided as a result of the decision that a log including a specific term exists in the logs converted by the process at S62 exists (YES at S71), the character information conversion unit 115 converts character information included in the log corresponding to the user specified by the process at S41 from among the existing logs by the process at S71 into third character information having confidentiality lower than confidentiality of the first character information (S73).

For example, when there exists a log including a specific term included in “phenomenon” of the incident information 131, the character information conversion unit 115 decides that the existing log corresponds to the substance of the inquiry accepted from the user. Therefore, the character information conversion unit 115 decides that the log including the specific term is a log having very high possibility that it may be used in the investigation and further decreases the confidentiality of the log including the specific term. In the following, a log after character information thereof is converted by the process at S73 is described.

[Particular Example (2) of Log after Conversion of Character Information]

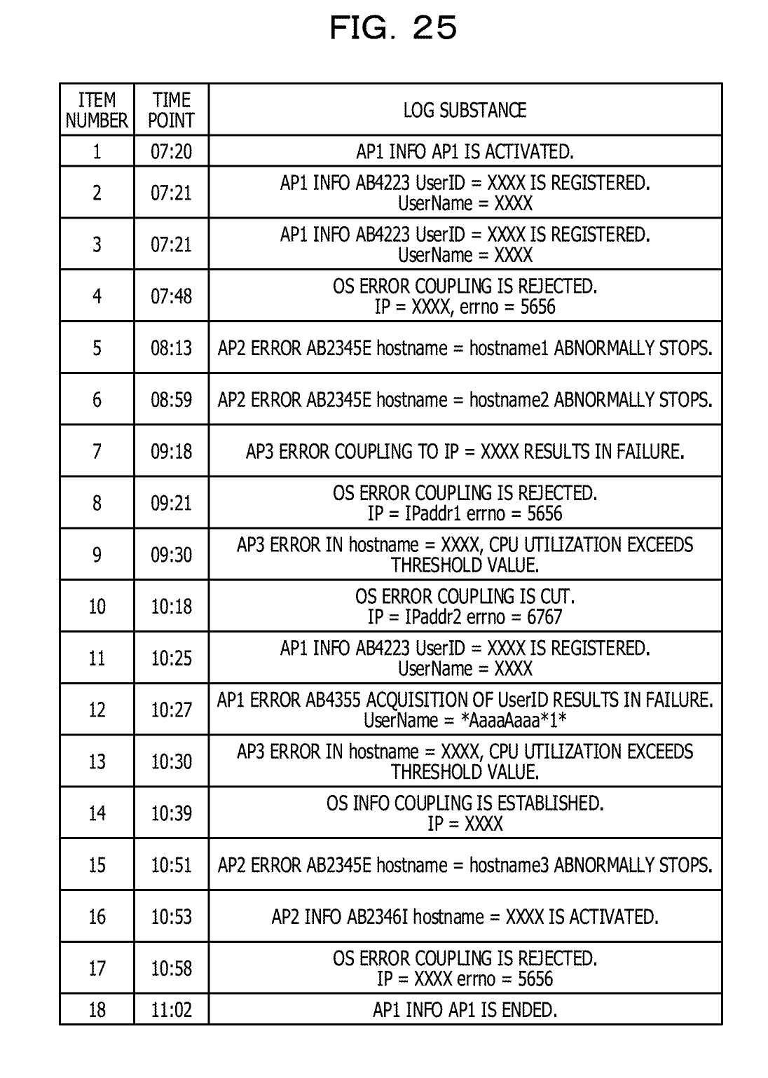

FIG. 25 is a view illustrating a particular example of logs after character information thereof is converted by the process at S73. For example, only a log whose “item number” is “12” from among the first logs depicted in FIG. 25 is a log that includes the character information configured from “*TestUser#1*” that is a specific term, character information configured from “AP1,” “AP2” or “OS” that is software utilized by the user specified by the process at S41 and character information configured from “ERROR.”

Therefore, as indicated by an underlined portion of FIG. 25, the character information conversion unit 115 converts, for example, character information following “Username=” from within information set to “log substance” of the log whose “item number” is “12” in the log information 231 described hereinabove with reference to FIG. 24 from “Username1” into “*AaaaAaaa*1*” that is third character information.

This makes it possible for the character information conversion unit 115 to further decrease the possibility that the investigation by the person in charge of support may be obstructed by concealment of logs.

Referring back to FIG. 14, if it is decided that a log including a specific term does not exist in the logs converted by the process at S62 (NO at S71), the character information conversion unit 115 converts character information included in a log corresponding to the user specified by the process at S41 from among the first logs converted by the process at S62 into third character information having lower confidentiality than confidentiality of the first character information (S72).

For example, if a log including a specific term included in “phenomenon” of the incident information 131 does not exist, the character information conversion unit 115 fails to specify a log having extremely high possibility that it may be used in the investigation from among the logs included in the first logs. Therefore, the character information conversion unit 115 first decreases, for example, the confidentiality of character information included in the first logs uniformly. In the following, the logs after character information thereof is converted by the process at S72 are described.

[Particular Example (3) of Log after Conversion of Character Information]

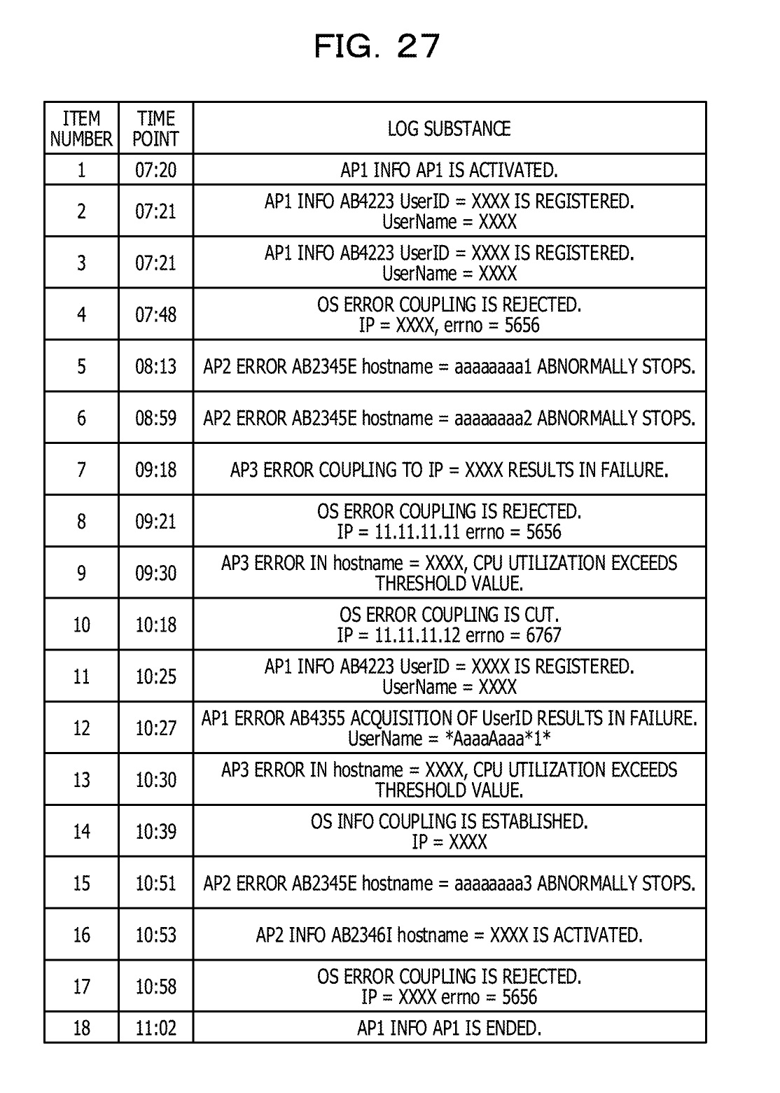

FIG. 26 is a view depicting a particular example of the incident information 131 different from the incident information 131 described hereinabove with reference to FIG. 15. Further, FIG. 27 is a view illustrating a particular example of logs after character information thereof is converted by the process at S72.

First, the incident information 131 depicted in FIG. 26 is described. In “indent number,” “date and time of occurrence,” “user” and “generation software” of the incident information 131 depicted in FIG. 26, information same as that of the incident information 131 described hereinabove with reference to FIG. 15 is set. Further, in “phenomenon” of the incident information 131 depicted in FIG. 26, character information of the substance that “CPU utilization of a plurality of servers remain exceeding an upper limit threshold value.” is set.

Here, the character information set in “phenomenon” of the incident information 131 depicted in FIG. 26 does not include character information other than general terms. Therefore, the character information conversion unit 115 decides that a log including a specific term does not exist in the logs whose character information is converted by the process at S62 (NO at S71). Accordingly, in this case, the character information conversion unit 115 converts character information included in logs that include the character information configured from “AP1,” “AP2” or “OS” that is software utilized by the user specified by the process at S41 and the character information configured from “ERROR” from among the logs existing by the process at S71 into third character information.

Now, particular examples of a log after character information of the same is converted by the process at S72 is described. Among the first logs depicted in FIG. 27 (logs whose “item number” is “5” to “15”), logs whose “item number” is “5,” “6,” “8,” “10,” “12” and “15” are logs that include the character information configured from “AP1,” “AP2” or “OS” that is software utilized by the user specified by the process at S41 and the character information configured from “ERROR.”

Therefore, as indicated by an underlined portion of FIG. 27, the character information conversion unit 115 converts, for example, character information following “hostname=” from within information set to “log substance” of the log whose “item number” is “5” in the log information 231 described hereinabove with reference to FIG. 24 from “hostname1” into “aaaaaaaa1” that is third character information. Further, the character information conversion unit 115 converts, for example, character information following “hostname=” from within information set to “log substance” of the log whose “item number” is “6” in the log information 231 described hereinabove with reference to FIG. 24 from “hostname2” into “aaaaaaaa2” that is third character information. Further, the character information conversion unit 115 converts, for example, character information following “IP=” from within information set to “log substance” of the log whose “item number” is “8” in the log information 231 described hereinabove with reference to FIG. 24 from “IPaddr1” into “11.11.11.11” that is third character information. Furthermore, the character information conversion unit 115 converts, for example, character information following “Username=” from within information set to “log substance” of the log whose “item number” is “12” in the log information 231 described hereinabove with reference to FIG. 24 from “Username1” into “*AaaaAaaa*1*” that is third character information.

Consequently, even when a log including a specific term included in “phenomenon” of the incident information 131 does not exist, the character information conversion unit 115 may further decrease the possibility that the investigation by the person in charge of support may be disturbed by concealment of logs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A log output apparatus comprising:
a memory; and
a processor coupled to the memory and the processor configured to:
specify an occurrence time when an incident has been occurred,
specify, from among a plurality of logs included in log information of software, a first log acquired within a first period according to the occurrence time and a second log acquired within a second period other than the first period in accordance with the log information stored in the memory, and
output new log information in which character information included in the first logs is converted into first character information having confidentiality higher than confidentiality of the character information and besides character information included in the second logs is converted into second character information having confidentiality higher than confidentiality of the first character information.

2. The log output apparatus according to claim 1, wherein the first period is a period from a time prior by a given time period to the occurrence time to another time later by another given time period than the occurrence time.

3. The log output apparatus according to claim 1, wherein the outputting of the new log information includes converting, when the first log includes character information of a specific type, the character information of the specific type into third character information having confidentiality lower than confidentiality of the first character information.

4. The log output apparatus according to claim 3, wherein the character information of the specific type is character information indicating that an abnormal situation occurs upon execution of the software.

5. The log output apparatus according to claim 3,
wherein the outputting of the new log information includes converting, when the first log includes a third log including a specific term included in the incident, character information included in the third log into the third character information, and
the processor is further configured to, when the first log does not include the specific term, perform of outputting of new log information in which character information included in the first log is converted into the third character information.

6. The log output apparatus according to claim 1, wherein the outputting of the new log information includes, when a log of software utilized by a user other than a specific user relating to the incident is included in the first logs, converting character information included in a log of software utilized by the specific user into the first character information and converting character information included in the log of the software utilized by the user other than the specific user into the second character information.

7. The log output apparatus according to claim 1,
wherein each of the plurality of logs is associated with each generation time of the plurality of logs, and
the processor is further configured to, prior to the outputting of the new log information, shift, when the first log does not includes a log that is acquired within a period from the occurrence time to an end of the first period and includes character information of a specific type, the end time of the first period to an acquisition time of a log including character information of the specific type after the first period.

8. The log output apparatus according to claim 1,
wherein each of the plurality of logs is associated with each generation time of the plurality of logs, and
the processor is further configured to, prior to the outputting of the new log information, shift, when the first log does not include a log relating to login of a specific user, a start time point of the first period to an acquisition time of a log relating to login of the specific user.

9. A log output method executed by a computer, the method comprising:
specifying an occurrence time when an incident has been occurred;
specifying, from among a plurality of logs included in log information of software, a first log acquired within a first period according to the occurrence time and a second log acquired within a second period other than the first period in accordance with the log information stored in a storage; and
outputting new log information in which character information included in the first logs is converted into first character information having confidentiality higher than confidentiality of the character information and besides character information included in the second logs is converted into second character information having confidentiality higher than confidentiality of the first character information.

10. The log output method according to claim 9, wherein the first period is a period from a time prior by a given time period to the occurrence time to another time later by another given time period than the occurrence time.

11. The log output apparatus according to claim 9, wherein the outputting includes converting, when the first log includes character information of a specific type, the character information of the specific type into third character information having confidentiality lower than confidentiality of the first character information.

12. The log output method according to claim 11, wherein the character information of the specific type is character information indicating that an abnormal situation occurs upon execution of the software.

13. The log output method according to claim 11,
wherein the outputting includes converting, when the first log includes a third log including a specific term included in the incident, character information included in the third log into the third character information, and
the method further comprising: when the first log does not include the specific term, outputting of new log information in which character information included in the first log is converted into the third character information.

14. The log output method according to claim 9, wherein the outputting includes, when a log of software utilized by a user other than a specific user relating to the incident is included in the first logs, converting character information included in a log of software utilized by the specific user into the first character information and converting character information included in the log of the software utilized by the user other than the specific user into the second character information.

15. The log output method according to claim 9,
wherein each of the plurality of logs is associated with each generation time of the plurality of logs, and
the method further comprising, prior to the outputting: shift, when the first log does not includes a log that is acquired within a period from the occurrence time to an end of the first period and includes character information of a specific type, the end time of the first period to an acquisition time of a log including character information of the specific type after the first period.

16. The log output method according to claim 9,
wherein each of the plurality of logs is associated with each generation time of the plurality of logs, and
the method further comprising, prior to the outputting: shift, when the first log does not include a log relating to login of a specific user, a start time point of the first period to an acquisition time of a log relating to login of the specific user.

17. A non-transitory computer-readable medium storing a program that causes a computer to execute a process comprising:
specifying an occurrence time when an incident has been occurred;
specifying, from among a plurality of logs included in log information of software, a first log acquired within a first period according to the occurrence time and a second log acquired within a second period other than the first period in accordance with the log information stored in a storage; and
outputting new log information in which character information included in the first logs is converted into first character information having confidentiality higher than confidentiality of the character information and besides character information included in the second logs is converted into second character information having confidentiality higher than confidentiality of the first character information.
